(19) United States
(12) Patent Application Publication
(10) Pub. No.: US 2014/0060795 A1
(43) Pub. Date: Mar. 6, 2014

(54) CONCEALED DYNAMIC VENTILATION SYSTEM

(71) Applicant: Jeffrey N. Yu, Honolulu, HI (US)

(72) Inventor: Jeffrey N. Yu, Honolulu, HI (US)

(21) Appl. No.: 14/019,458

(22) Filed: Sep. 5, 2013

Related U.S. Application Data
(60) Provisional application No. 61/697,625, filed on Sep. 6, 2012.

(51) Int. Cl. B60H 1/00

(52) U.S. Cl. CPC B60H 1/00821; B60H 1/00028
USPC 165/202; 454/152

(57) ABSTRACT

The disclosure herein provides methods, systems, and devices for ventilating the interior of a vehicle with concealed dynamic ventilation system. A concealed dynamic ventilation system and vents thereof can beneficially provide one or more passengers in a vehicle with an increased distribution of air substantially throughout the cabin of a vehicle as compared with traditional vents that are limited to fixed locations with limited capabilities. Further, a concealed dynamic ventilation system can provide aesthetic value by concealing the vents from a passenger's line of sight in a normal seating position behind existing trims of a vehicle.

### CROSS REFERENCE TO RELATED APPLICATIONS

This application claims the benefit of U.S. Provisional Patent Application Ser. No. 61/697,625, filed Sep. 6, 2012, entitled “CONCEALED DYNAMIC VENTILATION SYSTEM,” which is hereby incorporated herein by reference in its entirety.

### BACKGROUND

1. Field

The embodiments herein relate generally to heating and cooling ventilation (“HVAC”) systems and more particularly to concealed dynamic ventilation systems in vehicles.

2. Description

With the development of new technologies, automobile companies have manufactured cars with various types of vents to provide heating, cooling, and air circulation to passengers to increase passenger comfort in the cabin of the vehicle. These vents typically comprise small, thin, horizontal or vertical flaps that function as air directors to guide the air in the main cabin of the vehicle. Despite improvements in HVAC systems, vents are naturally limited by their size and configuration. In most cases, vents are only able to provide limited quantities of air over a limited range of motion to passengers in the vehicle. With such vents in vehicles, passengers frequently must wait to experience heating or cooling as air exits through the minimal cross sectional area and diffuses throughout the vehicle. Often, poor circulation of air results in the localization of air in particular regions of the vehicle as well. In addition, passengers in the rear of the vehicle may be limited to limited and/or smaller vents in the rear cabin or vents that are located in the front of the cabin on the dashboard to receive ventilation as some vehicles do not provide independent vents for the rear cabin. As a result, passengers in the rear may experience different amounts of air flow as passengers in the front cabin. Further, due to one or more of the shortcomings mentioned above, passengers may increase the level of air flow in the car in an attempt to expedite or otherwise improve the cooling, heating, and/or air circulation. However, this is often accompanied by an increase in the volume of the HVAC system that can present a wholly separate discomfort to the passengers.

### SUMMARY

Advancements in HVAC system technology make it possible to ventilate a vehicle with concealed dynamic ventilation system vents that may be located throughout the cabin of a vehicle to provide for a more efficient cooling, heating, and ventilation experience overall.

In some embodiments, an apparatus for ventilating an interior of a vehicle can include an air source, an air duct coupled to the air source, and a plurality of air vents each having an opening coupled to the air duct configured to deliver air to the interior of the vehicle, and an air vent opening cover over at least a portion of at least one of the plurality of air vent openings, the air vent opening cover including a portion of a vehicle interior trim.

In some embodiments, at least one of the plurality of air vent openings has an elongate shape and extends along a length of at least one of a vehicle A pillar and a vehicle B pillar. At least one of the plurality of air vent openings may extend along a length of least one of a vehicle dashboard, a vehicle seat, a vehicle door, and a vehicle roof panel.

In some embodiments, at least one of the plurality of air vent openings is defined at least in part by two adjacent surfaces of a vehicle dashboard trim or an interior vehicle door trim. An air-directing component may be included within the at least one of the plurality of air vent openings, the air-directing component coupled to one of the two adjacent surfaces and configured to rotate around a pivot point or move along an axis to guide air flow through the at least one of the plurality of air vent openings.

In some embodiments, the portion of the vehicle interior trim moves in at least one of a horizontal direction toward the interior of the vehicle, an upward direction and a downward direction. In some embodiments, the portion of the vehicle interior trim rotates around an axis to vary an amount of air flow through the at least one of the plurality of air vent openings

In some embodiments, the apparatus for ventilating an interior of a vehicle can include a temperature sensor configured to detect a temperature of the interior of the vehicle, and a control module configured to receive a signal from the temperature sensor indicative of the temperature in the interior of the vehicle, and to control a movement of the air vent opening cover to direct an air flow through the at least one of the plurality of air vent openings in response to a signal indicating the temperature in the interior of the vehicle is greater than or lower than a threshold temperature value. The air vent opening cover may rotate around an axis in response to a control signal from the control module.

In some embodiments, a cross-section dimension of the air duct increases as a distance from the air source increases.

In some embodiments, the apparatus for ventilating an interior of a vehicle can include a thermoelectric device within a space of a vehicle door, the space being coupled to the at least one of the plurality of air vent openings, wherein air heated or cooled by the thermoelectric device is delivered to the interior of the vehicle through the at least one of the plurality of air vent openings.

An apparatus for ventilating an interior of a vehicle can include an air source, an air duct coupled to the air source, and an air vent having an opening coupled to the air duct for delivering air to the interior of the vehicle, the air vent opening being substantially concealed by a portion of a vehicle interior trim at least when the air vent is in a closed position.

In some embodiments, the air vent opening has an elongate shape and extends along a length of at least one of a vehicle A pillar and a vehicle B pillar. In some embodiments, the air vent is in a vehicle dashboard, a vehicle seat, a vehicle door, or a vehicle roof. In some embodiments, the air vent opening is defined at least in part by two adjacent surfaces of a portion of a vehicle dashboard trim or a portion of a vehicle interior door trim.

In some embodiments, the portion of the vehicle interior trim moves in at least one of a horizontal direction toward the interior of the vehicle, an upward direction and a downward direction. The portion of the vehicle interior trim may rotate around an axis to vary an amount of air flow through the at least one of the plurality of air vent openings.

A system for ventilating an interior of a vehicle can include an air vent opening for delivering air to the interior of the vehicle and a corresponding air vent opening cover over the air vent opening, the corresponding air vent opening cover comprising a portion of a vehicle interior trim and substantially concealing the air vent opening.

In some embodiments, the portion of the vehicle interior trim moves in at least one of a horizontal direction toward the interior of the vehicle, an upward direction and a downward direction. In some embodiments, the portion of the vehicle interior trim rotates around an axis to vary an amount of air flow through the air vent opening.

For purposes of this summary, certain aspects, advantages, and novel features of the invention are described herein. It is to be understood that not necessarily all such advantages may be achieved in accordance with any particular embodiment of the invention. Thus, for example, those skilled in the art will recognize that the invention may be embodied or carried out in a manner that achieves one advantage or group of advantages as taught herein without necessarily achieving other advantages as may be taught or suggested herein.

### BRIEF DESCRIPTION OF THE DRAWINGS

The foregoing and other features, aspects and advantages of the present invention are described in detail below with reference to the drawings of various embodiments, which are intended to illustrate and not to limit the invention. The drawings comprise the following figures in which:

FIG. 1A depicts an example of a vent configuration of a traditional HVAC system in a front cabin of a vehicle.

FIG. 1B depicts an example of one embodiment of a vent configuration of a concealed dynamic ventilation system in a front cabin of a vehicle.

FIG. 1C depicts an example of one embodiment of a vent configuration of a concealed dynamic ventilation system substantially surrounding a center console in a front cabin of a vehicle.

FIG. 2A depicts an example of a vent configuration of a traditional HVAC system in a door of a vehicle.

FIG. 2B depicts an example of one embodiment of a vent configuration of a concealed dynamic ventilation system in a door of a vehicle.

FIG. 2C depicts an example of one embodiment of a vent configuration of a concealed dynamic ventilation system in a door of a vehicle.

FIG. 3A depicts an example of a vent configuration of a traditional HVAC system in a rear cabin of a vehicle.

FIG. 3B depicts an example of one embodiment of a vent configuration of a concealed dynamic ventilation system in a rear cabin of a vehicle.

FIG. 4A depicts a side view of an example of one embodiment of a vent configuration of a concealed dynamic ventilation system in a roof of a vehicle.

FIG. 4B depicts a top view of an example of one embodiment of a vent configuration of a concealed dynamic ventilation system in a roof of a vehicle.

FIGS. 5A-5B depict an example of one embodiment of a vent configuration of a concealed dynamic ventilation system with an air-directing mechanism.

FIGS. 6A-6C depict an example of one embodiment of an air directing mechanism of vent of a concealed dynamic ventilation system.

FIGS. 7A-7B depict an example of one embodiment of an open/close mechanism of a vent of a concealed dynamic ventilation system.

FIGS. 8A-8B depict an example of one embodiment of an open/close mechanism of a vent of a concealed dynamic ventilation system.

FIGS. 9A-9B depict an example of one embodiment of an open/close mechanism of a vent of a concealed dynamic ventilation system.

FIG. 10 depicts an example of one embodiment of one or more trims with an open/close mechanism that are located on a dashboard and/or door panel.

FIG. 11 depicts an example of one embodiment of flaps configured to direct air flow out of a duct vent of a concealed dynamic ventilation system.

FIG. 12 depicts an example of one embodiment of air ducts of a concealed dynamic ventilation system with different thickness depending on the location of the vent.

FIG. 13A depicts a cross section view of a vehicle door having a space in which a thermoelectric device is placed.

FIG. 13B depicts a cross section view of a vehicle door having a space in which a heating and/or cooling apparatus is placed.

### DETAILED DESCRIPTION

Embodiments of the invention will now be described with reference to the accompanying figures. The terminology used in the description presented herein is not intended to be interpreted in any limited or restrictive manner, simply because it is being utilized in conjunction with a detailed description of certain specific embodiments of the invention. Furthermore, embodiments of the invention may comprise several novel features, no single one of which is solely responsible for its desirable attributes or which is essential to practicing the inventions herein described.

The disclosure herein provides methods, systems, and devices for ventilating the interior of a vehicle with concealed dynamic ventilation system. A concealed dynamic ventilation system can be installed in any vehicle, including but not limited to an automobile, ship, or airplane. A concealed dynamic ventilation system can beneficially provide one or more passengers in a vehicle with an increased distribution of air substantially throughout the cabin of a vehicle as compared with traditional vents that are limited to fixed locations with limited capabilities, such as a dashboard of a vehicle. The increased cross sectional area of one or more vents of a concealed dynamic ventilation system can result in less air turbulence and/or buffeting of the passengers and provide more rapid and even distribution of air throughout the cabin.

In automobiles, vents of traditional HVAC systems are typically located in the front of a cabin on the dashboard, with one or more vents located on a center console, one or more vents located adjacent to a driver cockpit, and/or one or more vents located adjacent to a passenger in the front seat. In some vehicles, car manufacturer designers may provide a rear center console with one or more vents and/or vents under the front seats. There are usually few, if any, vents located on doors or pillars of the vehicle. As a result, passengers in a vehicle are limited by the amount of air that may be distributed via these fixed vents at any one time throughout the car, and passengers frequently must wait to experience heating or cooling as air exits through the minimal cross sectional area and diffuses throughout the vehicle. Often, poor circulation of air results in the localization of air in particular regions of the vehicle.

However, by employing a concealed dynamic ventilation system as described herein, more efficient cooling, heating, and/or air ventilation can be obtained due to vents with larger cross sectional areas and installation throughout the cabin of a vehicle. Because vents in a concealed dynamic ventilation system can comprise wider openings with larger cross sectional areas compared to traditional vents, increased distribution of air flow is possible. Also, because concealed dynamic ventilation system can be installed throughout the cabin of a vehicle and is not confined to locations of vents of traditional HVAC systems, a more even distribution of air is possible as well. At the same time, the strategic configuration of vents of a concealed dynamic ventilation system can even increase cabin space for other components compared to traditional HVAC systems.

Additionally, typical HVAC systems emit considerable levels of undesirable noise throughout the vehicle when the systems are in use. However, by providing a larger cross sectional area through which air can flow a concealed dynamic ventilation system can reduce the level of noise emitted for similar and/or improved ventilation capabilities. The system as a whole can also be more efficient because less force is required to for similar and/or higher levels of air flow as a consequence of the larger cross sectional area of the vents. In traditional HVAC systems, to ensure that a duct in the rear cabin gets air, a secondary fan is generally installed downstream from the main fan to pull air. However, vents of a concealed dynamic ventilation system with larger cross sectional areas can permit air to flow more easily throughout the perimeter of the interior of the vehicle. This can allow a concealed dynamic ventilation system to operate more efficiently with or without a secondary fan. As a result, concealed dynamic ventilation systems can improve fuel consumption levels in vehicles, including hybrid and/or electric vehicles.

Moreover, in modern vehicular design, there is a growing trend to install larger center console display screens. However, the size of the screen is limited by the amount of space that is remaining after allocating adequate space in the center console and adjacent areas in the dashboard for vents of traditional HVAC systems. Concealed dynamic ventilation systems present a solution in response to this industry trend in vehicular design. By reducing the amount of space devoted to vents while maintaining and/or improving the performance of ventilation systems, concealed dynamic ventilation systems can allow for larger console display screens that were not available in conjunction with traditional HVAC systems.

The numerous displays and buttons required in today's vehicles also leads to a great deal of clutter and demand for dashboard space. Concealed dynamic ventilation systems can provide more space and a cleaner aesthetic appearance to today's cluttered dashboards by removing unsightly traditional vents.

Overview

A concealed dynamic ventilation system can generally comprise an elongated opening or vent that can be located in one or more locations throughout the interior cabin of any vehicle. Cooled, heated, and/or unconditioned air can flow from an air source, through the opening and/or vent, and to the interior cabin of a vehicle. In some embodiments, one or more vents of a concealed dynamic ventilation system can be hidden from the line of sight of a passenger(s) in a normal seating position(s) despite their positioning all throughout the cabin interior for better air ventilation. In certain embodiments, the one or more vents are completely hidden and/or concealed from a point of view of a passenger(s). In some embodiments, the one or more vents are partially hidden and/or concealed from a point of view of a passenger(s). In other embodiments, the one or more vents are not hidden and/or concealed.

One or more vents of a concealed dynamic ventilation system can comprise any shape. For example, in some embodiments, one or more vents of a concealed dynamic ventilation system can be substantially linear, angular, curved, parabolic, triangular, rectangular, square, pentagonal, hexagonal, heptagonal, and/or octagonal in shape.

In some embodiments, a trim housing comprising a trim portion conceals a vent of a concealed dynamic ventilation system behind the trim portion. For example, one or more edges of a trim can define one or more boundaries of a vent of a concealed dynamic ventilation system. In certain embodiments, a vent of a concealed dynamic ventilation system is substantially linear in shape along the edges of a trim. The trim can be made of fabric, leather, wood, carbon fiber, alcantera, stone, graphite, alloy, vinyl, different material from the dash, same material as the dash, and/or any other material.

In other embodiments, a vent or opening of a concealed dynamic ventilation system is defined by one or more edges of a surface of a dashboard and/or door panel. The one or more edges of a surface of a dashboard and/or door panel that defines the vent or opening can comprise the same or different material as the rest of the dashboard and/or door panel. Further, the one or more edges of a surface that defines the vent or opening can comprise fabric, leather, wood, carbon fiber, alcantera, stone, graphite, alloy, vinyl and/or any other material

In some embodiments, a first surface of a dashboard or door panel can comprise a lip or area that overlaps a portion of a second surface of the dashboard or door panel, wherein the area between the two surfaces provide a vent, opening, and/or passageway of air in a concealed dynamic ventilation system. Accordingly, a vent(s) of a concealed dynamic ventilation system can be concealed from a line of sight of a passenger(s) in a normal seating position. The first and/or second surface that provides the vent, opening, and/or air passageway can comprise the same and/or different material as the rest of the dashboard and/or door panel. Further, the first and/or second surface can comprise fabric, leather, wood, metal, stone, graphite, alloy, vinyl and/or any other material.

In some embodiments, one or more surfaces that define and/or provide a vent or opening of a concealed dynamic ventilation system can be monolithic and/or contiguous with the rest of the dashboard and/or door panel. However, in other embodiments, the one or more surfaces can comprise a separate layer and/or structure from the rest of the dashboard and/or door panel.

In certain embodiments, one or more features of a concealed dynamic ventilation system or vents thereof can be used alone or in conjunction with traditional HVAC systems, vents thereof, and/or traditional trim configurations to provide improved ventilation within the cabin and/or any other advantages described herein.

Front Cabin

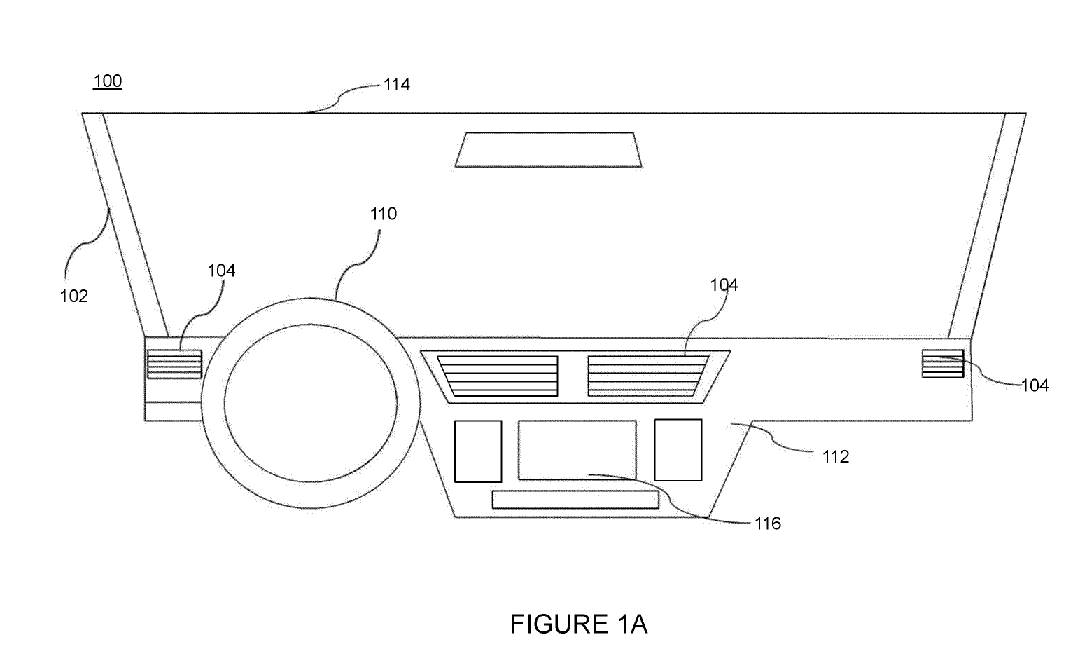

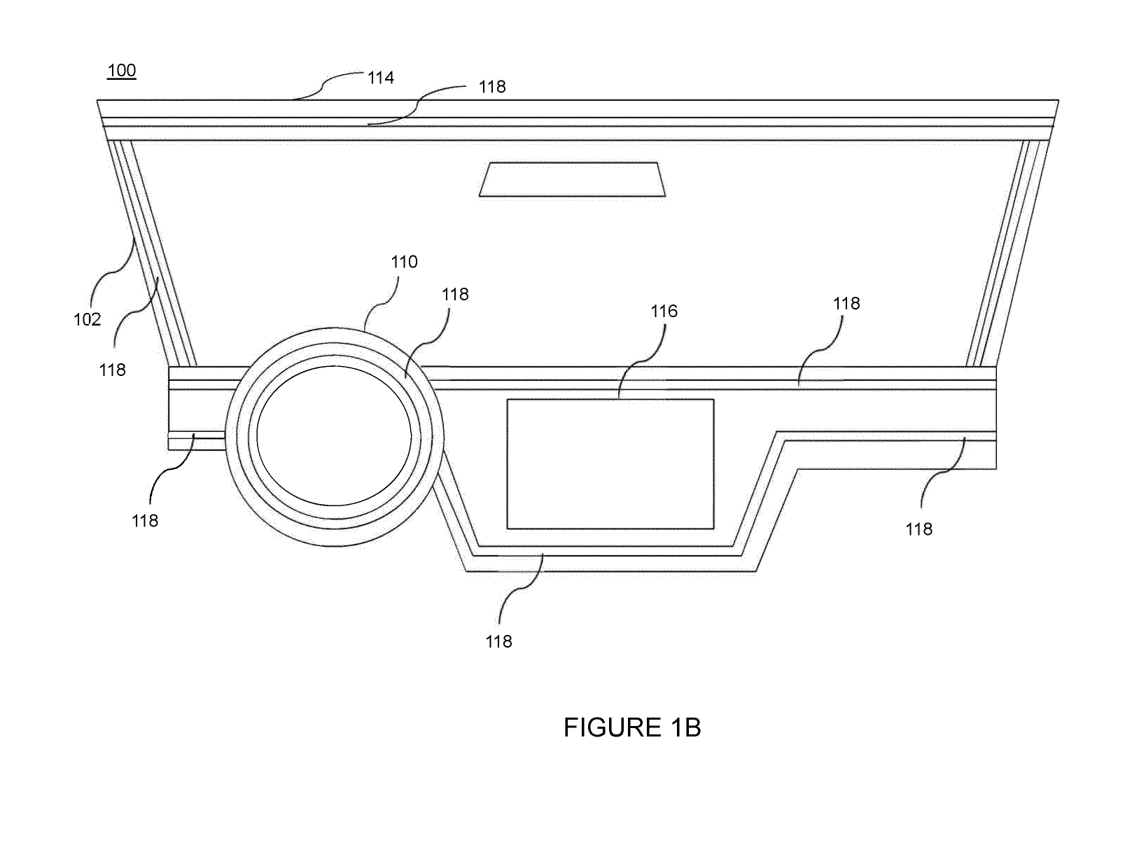

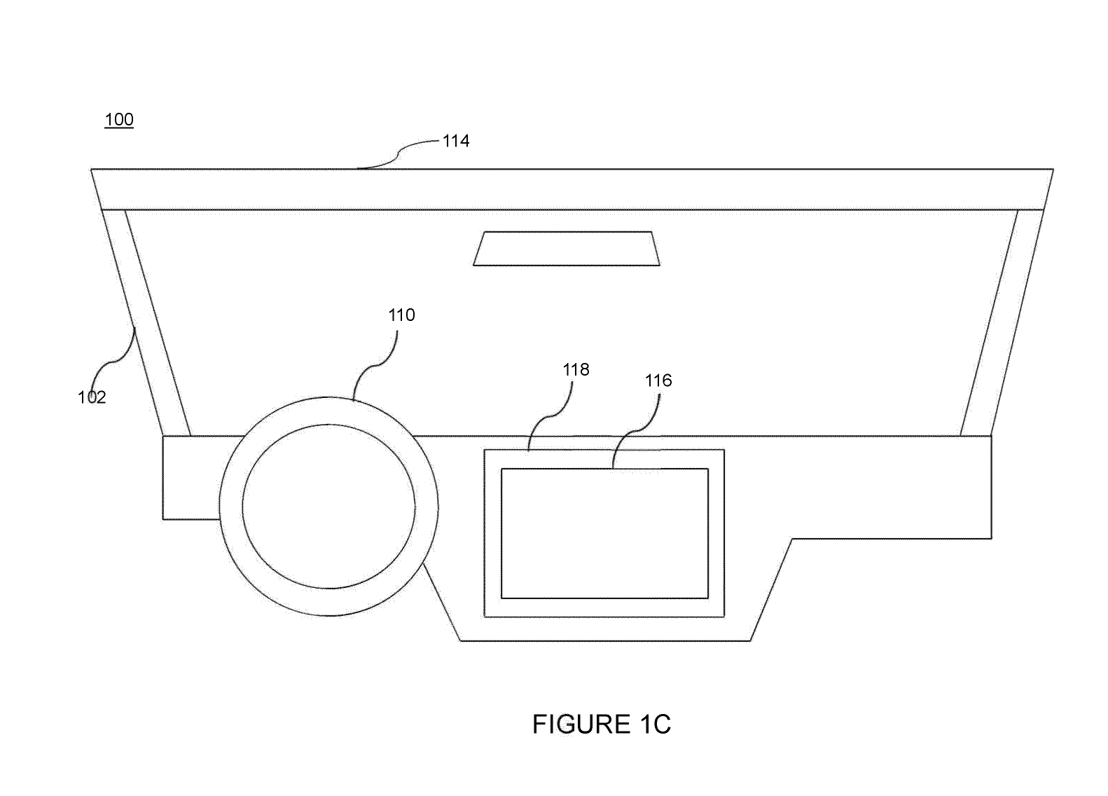

FIG. 1A shows an example of the interior of a front cabin of a vehicle 100 with one or more vents 104 of a traditional HVAC system. The one or more vents 104 may be located in the center console 112, adjacent to the steering wheel 110 in the driver cockpit, and/or adjacent to the passenger in the front seat. As illustrated, the one or more vents 104 can take up a substantial amount of space in the cabin interior, thereby limiting space for other components that may be installed in the center console or other parts of the cabin. For example, vents 104 take up a considerable amount of space in the front dashboard and limit the size and/or configuration of other components, such as a center console display screen 116.

FIG. 1B shows an example one embodiment of a vent configuration of a traditional HVAC system in a front cabin of a vehicle. In some embodiments, one or more vents 118 of a concealed dynamic ventilation system can be located substantially within one or more A-pillars 102. In certain embodiments, one or more vents 118 of a concealed dynamic ventilation system can be located in substantially a part of a roof panel 114 of the interior. In some embodiments, one or more vents 118 of a concealed dynamic ventilation system can be located substantially in the steering wheel 110. In certain embodiments, one or more vents 118 of a concealed dynamic ventilation system can be located substantially in one or more portions of a dashboard of a vehicle.

In some embodiments, one or more vents 118 of a concealed dynamic ventilation system or portions thereof can be substantially linear and elongated in shape. For example, in certain embodiments, one or more vents 118 of a concealed dynamic ventilation system can run substantially the length of a dashboard, A-pillar, and/or roof panel. In certain embodiments, one or more vents 118 of a concealed dynamic ventilation system or portions thereof can be circular and/or curved in shape. For example, a circular vent 118 of a concealed dynamic ventilation system can be located within the rims of a steering wheel 110. In certain embodiments, one or more vents 118 of a concealed dynamic ventilation system or portions thereof can be angular and/or curved in shape. For example, a vent 118 of a concealed dynamic ventilation system can be linear, angled, and/or curved in some portions to substantially trace an edge of a dashboard and/or linear or triangular support structures.

FIG. 1C of one embodiment of a vent configuration of a concealed dynamic ventilation system substantially surrounding a center console display screen in a front cabin of a vehicle 100. In the depicted embodiment, a vent 118 of a concealed dynamic ventilation system is substantially rectangular in shape and substantially surrounding the circumference of a center console display screen 116. In certain embodiments, one or more vents 118 of a concealed dynamic ventilation system can be of any shape and can substantially surround any component or panel inside of the cabin of a vehicle.

As illustrated, one or more vents 118 of a concealed dynamic ventilation system can take up substantially less space compared to vents 104 of traditional HVAC systems. As a result, by utilizing concealed dynamic ventilation systems, more space is freed up in the cabin interior, which can allow for installation of additional or improved components or cleaner dashboard aesthetics. For example, in FIG. 1A, the size of a console display screen 116 is substantially limited by the space remaining after installing vents 104 of a traditional HVAC system. However, as shown in FIG. 1C, by installing a rectangular vent of a concealed dynamic ventilation system around the circumference of the console display screen 116, the size of the console display screen 116 is generally limited only by the size of the dashboard.

In addition, in some embodiments, by positioning one or more vents 118 of a concealed dynamic ventilation system throughout the cabin, as opposed to positioning vents 104 of a traditional HVAC system only at particular positions, air ducts that supply air to the vents 104 can also be located substantially throughout the cabin behind the cabin walls. For example, air ducts can be strategically positioned near or behind one or more electronic components or devices of the vehicle, such as a console display screen 116. In such embodiments, when an HVAC system is operating to cool the cabin, certain air ducts can be configured to deliver cool air to the electronic components or devices, thereby preventing the electronic devices and/or components from overheating. Because of the improved flexibility of positioning vents and ducts in a concealed dynamic ventilation system, air ducts can be generally installed in any location as desired.

Side Door

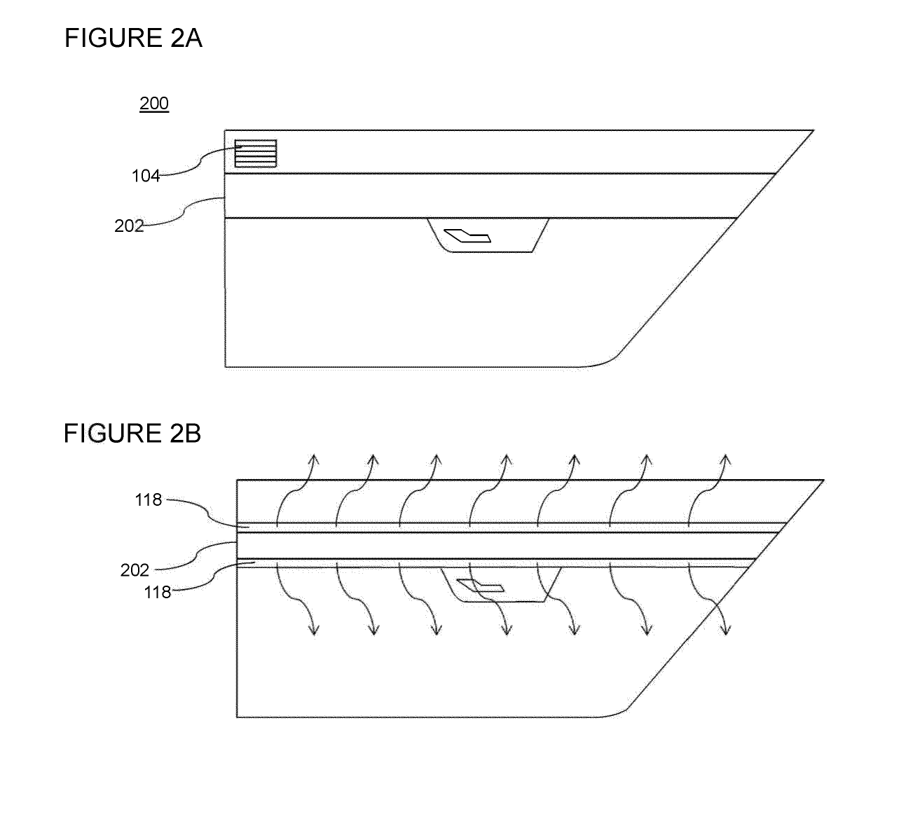

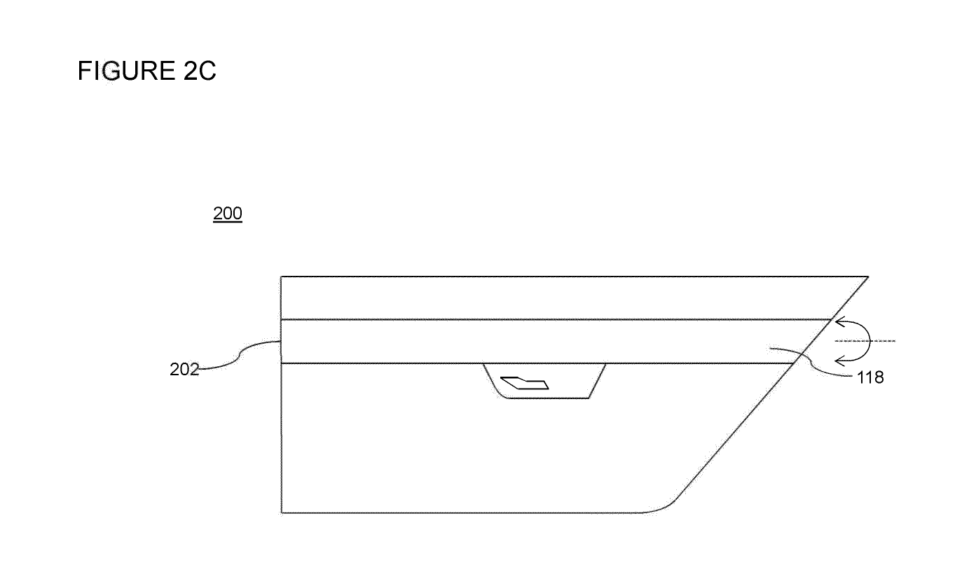

FIG. 2A shows an example of a vent configuration of a traditional HVAC system in a door of a vehicle. For example, a vent 104 of a traditional HVAC system can be located above a trim 202. Generally, air is pushed by one or fans from an air source near the front of the vehicle through ducts located inside the vehicle doors 200 and flow out of one or more vents 104. However, due to the small size of the one or more vents 104 generally installed in vehicle doors 200 and due to the distance of these vents 104 from the air source and from the passenger, the amount of air flow out of these vents 104 is generally limited.

On the other hand, vehicle doors 200 that comprise one or more vents 118 of a concealed dynamic ventilation system instead of traditional vents 104 can provide increased amounts of air flow due to the larger cross sectional area of the openings. Further, due to the larger cross sectional area of the openings, there is less air resistance. Accordingly, cooling, heating, and/or air circulation through the doors 200 can be more energy efficient with one or more vents 118 of a concealed dynamic ventilation system compared to traditional vents 104.

FIG. 2B shows an example of one embodiment of a door 200 of a vehicle comprising one or more vents 118 of a concealed dynamic ventilation system. In some embodiments, the one or more concealed dynamic ventilation system vents 118 may be located substantially above and/or below one or more trims 202 or parts of a door. For example, air can be pushed out in a substantially upward direction from a concealed dynamic ventilation system vent located substantially above one or more trims 202. Similarly, air can be pushed out in a substantially downward direction from a concealed dynamic ventilation system vent located substantially below one or more trims 202. In certain embodiments, the one or more concealed dynamic ventilation system vents 118 may be hidden from a passenger's viewpoint behind the one or more trims 202 on a door or portions of door panel.

In some embodiments, the one or more concealed dynamic ventilation system vents 118 may extend substantially the length of a door 200. In other embodiments, the one or more concealed dynamic ventilation system vents 118 may extend a portion of the length of a door 200. The one or more concealed dynamic ventilation system vents 118 may be located in one or more of many directions. For example, the one or more concealed dynamic ventilation system vents 118 may extend horizontally, vertically, or diagonally along the length of a door 200.

In certain embodiments, an air duct is located behind one or more trims 202 or a portion thereof. When the HVAC is off, the air duct can be closed off behind the one or more trims and preventing air from flowing from the air duct to the cabin interior. When the HVAC system is turned on, the one or more trims 202 can move out from a locked position in a substantially horizontal direction towards the interior of the cabin, resulting in a gap between the top and/or bottom edges of the one or more trims 202 and the air duct. Air can flow out of the opening that is created between the edges of the one or more trims 202 and the air duct. For example, air can flow in a substantially upward direction from the gap between the top edge of the one or more trims 202 and the air duct. Similarly, air can flow in a substantially downward direction from the gap between the bottom edge of the one or more trims 202 and the air duct.

FIG. 2C shows another example of one embodiment of a door of a vehicle 200 with one or more concealed dynamic ventilation system vents 118. In some embodiments, when the HVAC is off, the air duct can be closed off behind the one or more trims and preventing air from flowing from the air duct to the cabin interior. When the HVAC system is turned on, the one or more trims 202 can rotate along a horizontal axis. For example, the one or more trims 202 can rotate about 90 degrees along a horizontal axis on the centerline of the one or trims 202. Once rotated, the side of the concealed dynamic ventilation system vent 118 that faces the interior of the cabin can comprise one or more holes that air can flow through.

Rear Cabin

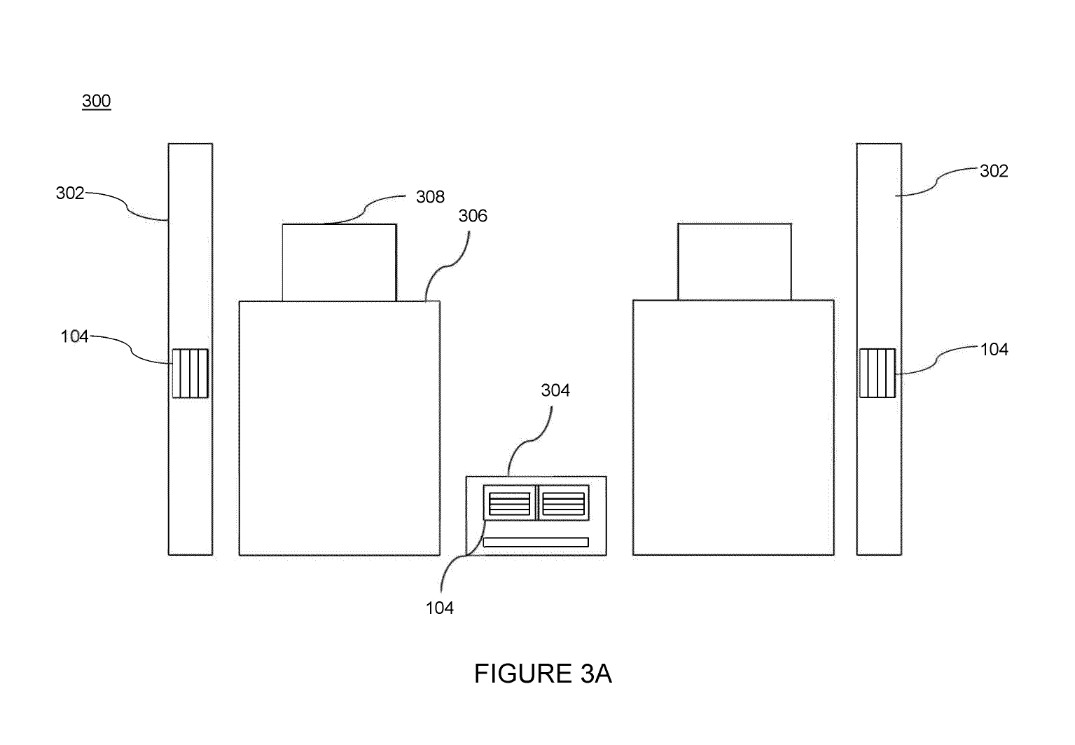

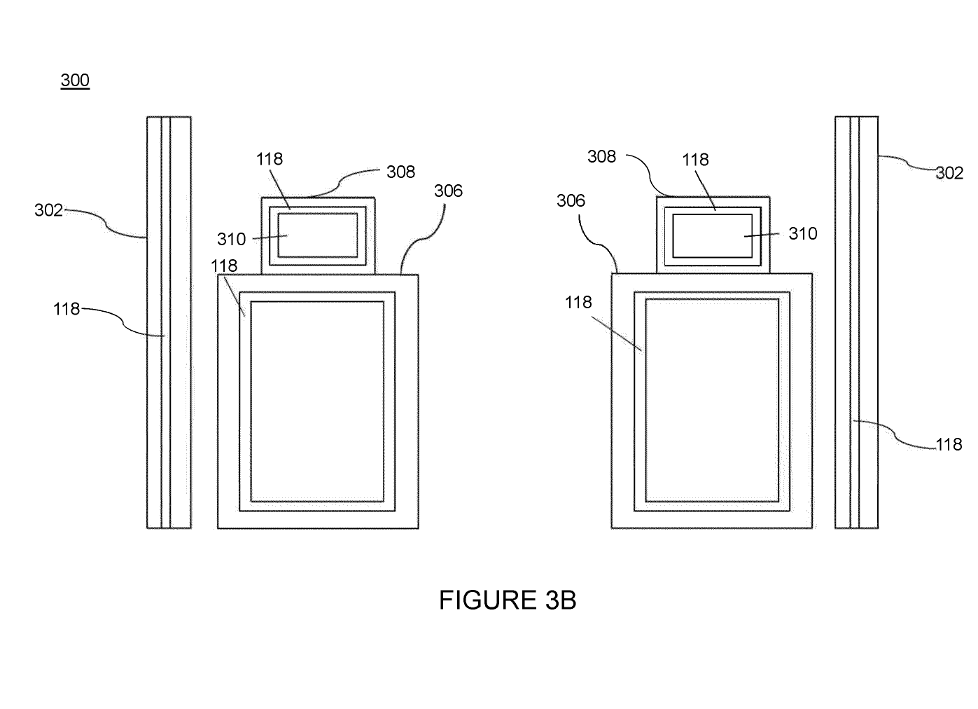

FIG. 3A depicts an example of a rear cabin interior 300 of a vehicle comprising one or more vents 104 of a traditional HVAC system. The one or more vents 104 may be located in one or more B-pillars 302 and/or a rear console 304. Similar to vents on the side doors, due to the small size of the one or more vents 104 generally installed in the rear cabin 300 and due to the distance of these vents 104 from the air source near the front of the vehicle, the amount of air flow out of these vents 104 is generally limited.

On the other hand, rear cabins 300 that comprise one or more concealed dynamic ventilation system vents 118 instead of traditional vents 104 can provide increased amounts of air flow due to the larger cross sectional area of the openings. Further, due to the larger cross sectional area of the openings, there is less air resistance. Accordingly, cooling, heating, and/or air circulation in the rear cabin 300 can be more energy efficient with one or more concealed dynamic ventilation system vents 118 compared to traditional vents 104.

FIG. 3B depicts an example of a rear cabin interior of a vehicle 300 with one or more concealed dynamic ventilation system vents 118. In some embodiments, the one or more concealed dynamic ventilation system vents 118 may be located in one or more B-pillars 302. In certain embodiments, the one or more concealed dynamic ventilation system vents 118 may extend along substantially the length of a B-pillar 302. Alternatively, the one or more concealed dynamic ventilation system vents 118 may extend along a portion of the B-pillar 302.

In other embodiments, the one or more concealed dynamic ventilation system vents 118 may be located in one or more headrests 308 of a front passenger seat 306. In certain embodiments, the one or more concealed dynamic ventilation system vents 118 may be located in the back support portion of a front passenger seat 306. By providing one or more concealed dynamic ventilation system vents 118 on the headsets 308 and/or back support portion of a front passenger seat 306, air can flow directly at a rear passenger for faster cooling and/or heating, which is not possible by traditional vents and their locations (see FIG. 3A). Due to the direct cooling and/or heating, a desired temperature can also be reached sooner, allowing the HVAC system to be more energy efficient compared to when using traditional vents.

Roof Panel

Generally, automobiles do not comprise vents on the roof panel. However, air right underneath the roof is heated first before air in any other areas due to its direct exposure to the sun. Also, heated air generally rises and gathers near the top portion of a vehicle as well. Accordingly, it can be advantageous to cool the area right beneath the roof panel to more efficiently cool the general cabin interior. As such, in some embodiments, the roof panel comprises one or more concealed and/or not easily detectable dynamic ventilation system vents to directly cool the cabin area beneath the roof panel.

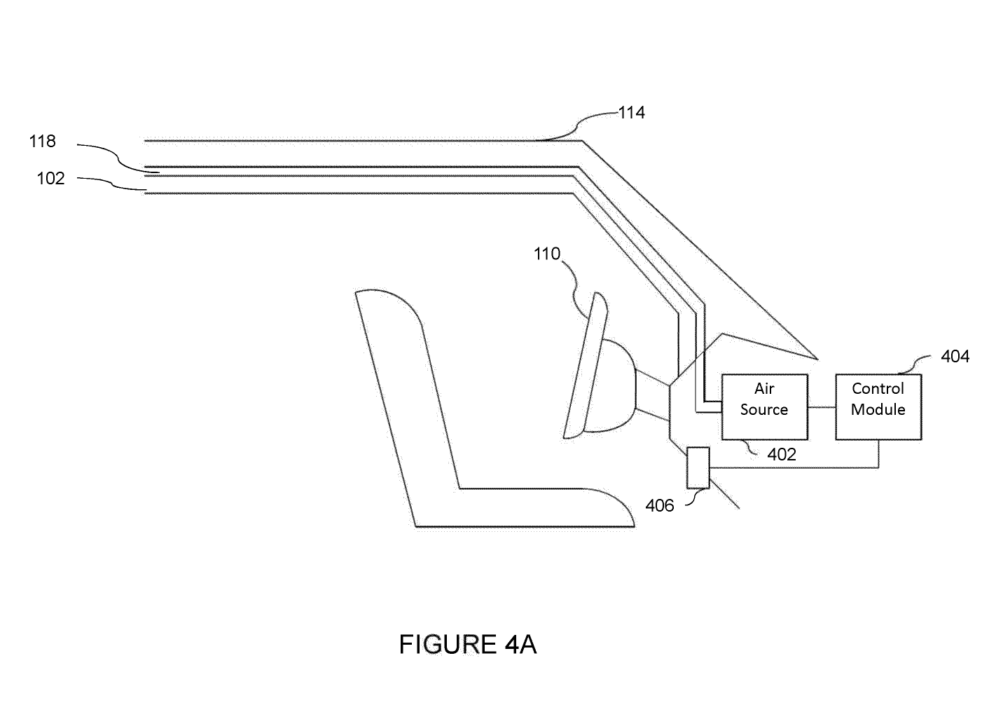

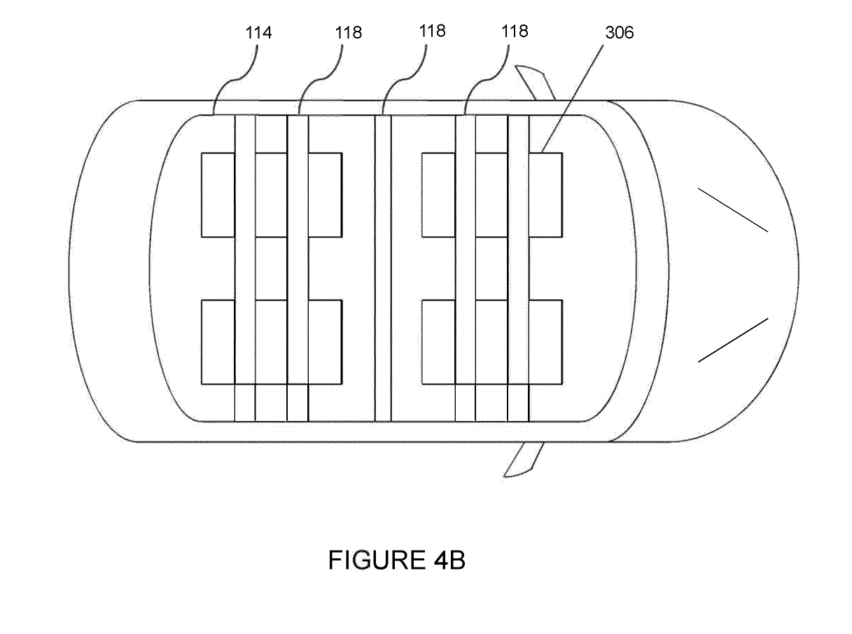

FIG. 4A depicts a side view of one embodiment of an interior of a vehicle with one or more concealed dynamic ventilation system vents 118. In the depicted embodiment, an air source 402 is located near the front of the vehicle. One or more air ducts can be configured to direct air from the air source 402 to the one or more concealed dynamic ventilation system vents 118 located throughout the interior of the vehicle cabin.

In some embodiments, a passenger of the vehicle can input a desired operating condition of the HVAC system via a user interface 406. For example, a passenger can control a desired temperature, air flow, direction of air flow, one or more vents to be utilized, among others via the user interface 406. In certain embodiments, the inputted control is transmitted to a control module 404. The control module 404 can be configured to control the HVAC system and/or concealed dynamic ventilation system according to the inputted configuration.

In some embodiments, the one or more concealed dynamic ventilation system vents 118 may be located substantially in a trim 102 of a roof panel 114. For example, one or more concealed and/or not easily detectable dynamic ventilation system vents 118 may extend longitudinally along the length of the A-pillar. In certain embodiments, the one or more concealed dynamic ventilation system vents 118 may extend substantially the length of the roof panel 114. In other embodiments, the one or more concealed dynamic ventilation system vents 118 may extend substantially a portion of the length of the roof panel 114.

FIG. 4B depicts a top view of one embodiment of an interior of a vehicle with one or more concealed dynamic ventilation system vents 118. In some embodiments, the one or more concealed dynamic ventilation system vents 118 may extend laterally across the width of a vehicle. In certain embodiments, the one or more concealed dynamic ventilation system 118 may extend substantially the length of the roof. In other embodiments, the one or more concealed dynamic ventilation system 118 may extend substantially a portion of the roof.

In some embodiments, the one or more concealed dynamic ventilation system vents 118 may extend in one or more of many directions. For example, the one or more concealed dynamic ventilation system vents 118 may extend substantially horizontally, vertically, diagonally, and/or in a curved configuration.

Air flowing through the one or more concealed dynamic ventilation system vents 118 located in a trim 102 of a roof panel 114 can directly cool and/or heat the area right below the roof panel 114. Also, air can be directed from one or more concealed dynamic ventilation system vents 118 directly towards passengers from above regardless of their seating location. For example, even if a passenger is sitting in a middle seat in the back row, cooled and/or heated air can be directly guided towards that passenger from the roof.

Directing Air—Stationary Vent

Despite the fact that one or more concealed dynamic ventilation system vents can be located throughout the interior of a vehicle cabin and direct air in all directions, it can still be advantageous to be able to further specify the direction of air flow by a passenger. In vents of traditional HVAC systems, louvers coupled to the vents generally direct air flow. In some embodiments, concealed dynamic ventilation system vents can also comprise similar louvers. In other embodiments, concealed dynamic ventilation system vents do not comprise louvers in the traditional sense, but rather comprise modified mechanisms for directing air as described herein.

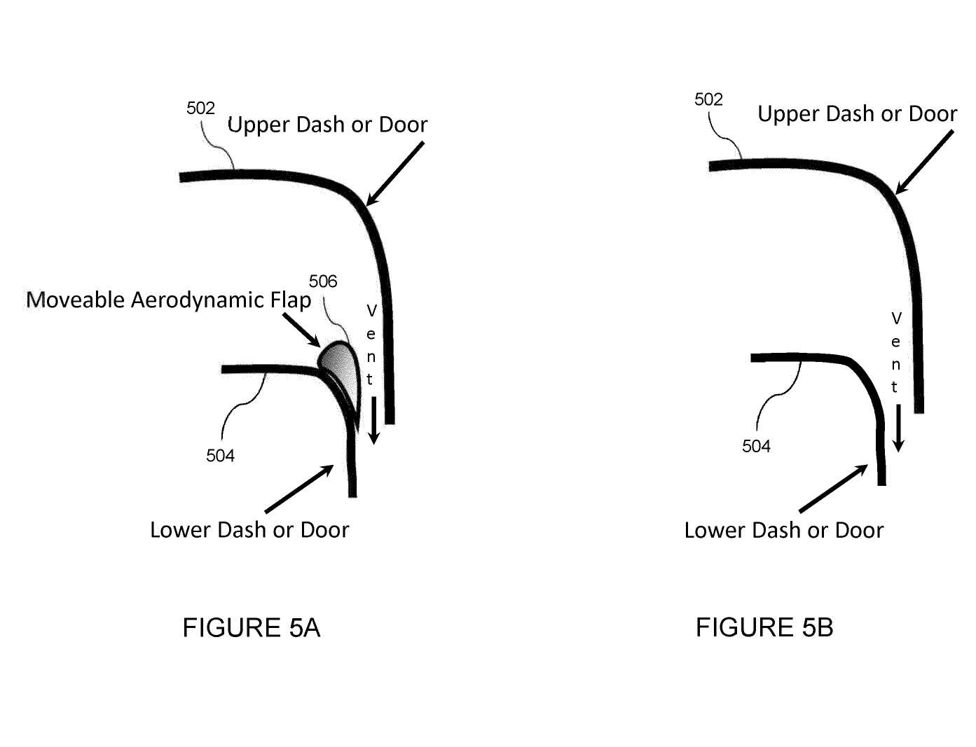

FIGS. 5A-5B show an example of one embodiment of a vent of a concealed dynamic ventilation system in a door and/or dashboard with an air-directing mechanism. In the depicted embodiment, a vent is provided by a plurality of surfaces of a dashboard and/or door panel. For example, a first surface 502 of a dashboard or door panel can comprise a lip or area that overlaps a portion of a second surface 504 of the dashboard or door panel, wherein the area between the two surfaces provide a vent, opening, and/or passageway of air in a concealed dynamic ventilation system. Accordingly, a vent(s) of a concealed dynamic ventilation system can be concealed from a line of sight of a passenger(s) in a normal seating position.

In some embodiments, the gap between the first surface 502 and second surface 504 can be about 1 inch, about 2 inches, about 3 inches, about 4 inches, about 5 inches, about 6 inches, about 7 inches, about 8 inches, about 9 inches, about 10 inches, or within a range defined by any of the aforementioned values.

Further, in certain embodiments, one or more flaps 506 can be coupled to one or more of the plurality of surfaces or can be located within the vent to direct air. For example, the one or more flaps 506 can be movable and/or rotatable along an axis or pivot point to guide air from the air duct through the vent in a particular direction, including but not limited to up, down, left, right, and/or to a certain degree thereof. In some embodiments, the one or more flaps 506 can be configured to guide air directly to a passenger's body and/or face despite the hidden configuration of the vent. Further, in certain embodiments, the one or more flaps 506 can be configured to substantially stop the flow of air from an air duct through the one or more vents. For example, the one or more flaps 506 can be rotated and/or otherwise moved to substantially block and/or divert an air passageway such that air substantially does not flow out of one or more vents.

Directing Air—Movable Vent

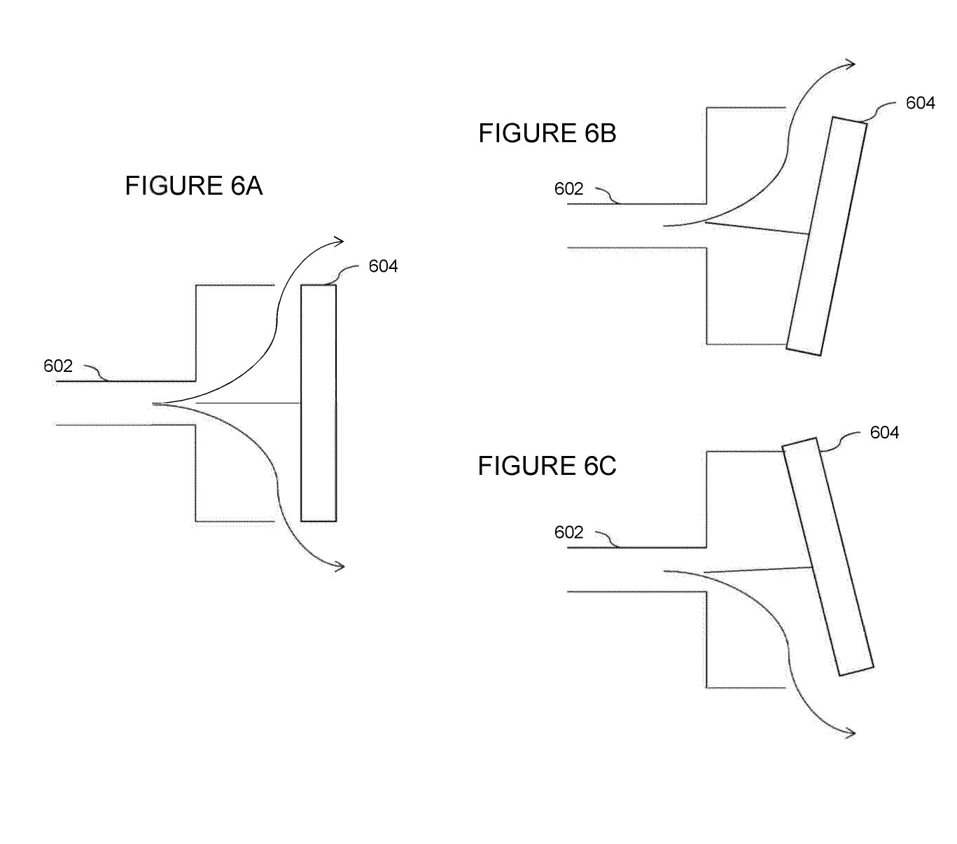

In contrast, in certain embodiments, the vent and/or opening of a concealed dynamic ventilation system itself is configured to move as to guide the air in a particular direction. FIGS. 6A-6C show an example of an embodiment of an air-directing mechanism of a concealed dynamic ventilation system vent. As shown in the depicted embodiment, a concealed dynamic ventilation system vent can be hidden and/or concealed behind one or more trims 604. In certain embodiments, one or more gaps can exist behind the one or more trims 604 and the rest of the interior cabin structure—for example, a front dashboard, side door, ceiling, etc.

In some embodiments, air can flow from an air source located near the front of a vehicle through one or more air ducts and through one or more vents of a concealed dynamic ventilation system to reach the interior cabin of a vehicle. A vent of a concealed dynamic ventilation system defined by a gap between a trim 604 and the remaining surface of the interior cabin can be positioned along any end of a trim 604. For example, a vent of a concealed dynamic ventilation system can be located at a top end, bottom end, proximal end, and/or distal end of a trim 604.

In some embodiments, when in a neutral state, air can be configured to flow from an air duct 602 through both the top and bottom openings of a concealed dynamic ventilation system vent, as shown in FIG. 6A. Air can flow in a substantially upward direction through the top opening of the concealed dynamic ventilation system vent and air can flow in a substantially downward direction through the bottom opening of a concealed dynamic ventilation system. Such air flowing upwards and downwards may differ in temperature and humidity.

In certain embodiments, the configuration of the trim 604 can be moved and/or altered to allow the air to flow in a particular direction of choice. For example, in the embodiment shown in FIG. 6B, a trim 604 is rotated downward along a horizontal axis to allow for a larger opening in the top while closing off the bottom opening. As a result, all of the air flowing from the air duct 602 is forced to go through the top opening in a substantially upward direction.

Similarly, in the embodiment shown in FIG. 6C, a trim 604 is rotated upwards in the opposite direction along a horizontal axis as to widen the bottom opening while substantially closing off the top opening. As a result, air flowing from the air duct 602 is forced to flow out of the bottom opening, rather than the top, in a substantially downward direction.

In some embodiments, a trim 604 can be configured to rotate to a particular degree of a passenger's choice. Accordingly, a user can choose to increase the air flow out of a particular opening by a certain degree, and decrease the air flow out of the other opening by a certain degree, as well, without completely closing off one of the air flows. By allowing a user to select a degree of rotation of a trim 604, the user can essentially choose the amount of air flow that he or she wishes to be directed in a particular direction. For example, a passenger can choose to open a top opening by about 30 degrees while closing the bottom opening by about 30 degrees.

In certain embodiments, one or more trim openings can be configured to be rotated left and/or right along a substantially vertical axis to direct more and/or less air to the left and/or right. For example, a passenger can choose to rotate a trim along a substantially vertical axis about 30 degrees to the left to close off a left opening about 30 degrees and to open a right opening about 30 degrees. This can allow the passenger to direct more and/or less air towards the window and/or center of the cabin.

The angle of rotation of a trim 604, either along a substantially vertical axis and/or a substantially horizontal axis, can be about 5°, about 10°, about 15°, about 20°, about 25°, about 30°, about 35°, about 40°, about 45°, about 50°, about 55°, about 60°, about 65°, about 70°, about 75°, about 80°, about 85°, or about 90°, or within a range defined by within a range defined by any of the aforementioned values.

In some embodiments, a passenger can simply push either the top, bottom, left, and/or right of a trim 604 to rotate the trim 604. For example, a trim 604 can be configured to rotate by an amount corresponding to the force of a push by a passenger. If a passenger pushes the top of a trim 604 with his or her finger to a certain degree, the trim 604 can rotate to open the bottom opening and close the top opening according to the amount of force exerted by the passenger.

In certain embodiments, one or more vents of a concealed dynamic ventilation system further comprise one or more knobs that are configured to mechanically rotate one or more trim 604. The one or more knobs can comprise a tactile surface. For example, if a passenger rotates a knob by a certain amount, the knob can translate that force of rotation to a trim 604 to rotate the trim 604 by that amount.

In some embodiments, one or more vents of a concealed dynamic ventilation system are coupled to an electromechanical system that is configured to automatically rotate a trim 604 covering a vent. In certain embodiments, the electromechanical system can comprise a user interface and a control module. For example, a passenger can input a command via the user interface to rotate a particular trim 604 by a particular degree. The user interface can further transmit the received command to a control module which can be configured to control the mechanical rotation of that particular trim by that particular angle.

In some embodiments, a trim 604 is configured to rotate around one or more pivot points. For example, in certain embodiments, a trim can be connected to a rod. A trim 604 can be configured to rotate around a pivot point defined by the point of contact between the rod and the interior of a trim. In certain embodiments, a trim 604 can be configured to rotate around a pivot point defined by the opposite end of the rod that is not in contact with the interior surface of the trim.

Targeted Cooling and/or Heating

Generally, heated air accumulates near the top of the cabin interior. Also, due to the proximity and direct exposure to outside heat, air near the top of a cabin interior is heated first, compared to other areas inside the cabin. Accordingly, it can be advantageous to direct conditioned cool air towards the top portion of the cabin interior first, before directing air towards other areas of the cabin. By initially targeting the cooled conditioned air towards the top of the cabin interior, the hottest air within the cabin interior is cooled first, thereby accelerating the cooling process of the cabin interior as a whole. This, in turn, can also save energy and time required for cooling.

Similarly, because cooled air can accumulate near the bottom of a cabin, it can be advantageous to direct heated air towards the bottom portion of the cabin first, before directing heated air towards other areas of the cabin. By initially targeting the heated air towards the bottom of the cabin interior, the coldest air within the cabin interior is heated first, thereby accelerating the heating process of the cabin interior as a whole. This, in turn, can also save energy and time required for heating.

As such, in some embodiments, one or more trims 604 are configured to be rotated or opened in certain directions to allow air to be directed substantially upwards and/or downwards. For example, when in cooling mode, if one or more temperature sensors located within the interior of the cabin detect that the temperature is above a threshold value, then upon turning on the HVAC system, one or more trims 604 can be configured to allow air to be directed in a substantially upward direction. After a certain amount of time and/or once the temperature within the cabin is lowered past a second threshold value, as detected by one or more temperature sensors, the one or more trims 604 can be further reconfigured to direct air to other parts of the cabin. For example, once the interior of the cabin has cooled down beyond a certain value, the one or more trims 604 can rotate from a position similar to that shown in FIG. 6B to a position similar to that shown in FIG. 6A and/or FIG. 6C to guide air more directly towards the passengers.

When in heating mode, if one or more temperature sensors located within the interior of the cabin detect that the temperature is below a threshold value, then upon turning on the HVAC system, one or more trims 604 can be configured to allow air to be directed in a substantially downward direction. After a certain amount of time and/or once the temperature within the cabin is raised past a second threshold value, as detected by one or more temperature sensors, the one or more trims 604 can be further reconfigured to direct air to other parts of the cabin. For example, once the interior of the cabin has warmed up beyond a certain value, the one or more trims 604 can rotate from a position similar to that shown in FIG. 6B to a position similar to that shown in FIG. 6A and/or FIG. 6C to guide air more directly towards the passengers.

Open/Close Mechanism of a Concealed Dynamic Ventilation System

In any ventilation system including the concealed dynamic ventilation system described herein, it can be important to be able to prevent dust and/or other undesirable particles from entering the system through the vents or openings. Accordingly, in some embodiments, one or more vents of a concealed dynamic ventilation system comprise an open/close mechanism. For example, a vent of a concealed dynamic ventilation system can be configured to open only when the HVAC system is turned on. Because air is generally blowing out of the system when the HVAC system is turned on, there is less chance that dust or other particles will enter the vent of a concealed dynamic ventilation system system through the vents and/or openings. On the contrary, when the HVAC system is turned off, a vent of a concealed dynamic ventilation system can be configured to substantially close its openings and/or vents to prevent dust and/or other particles from entering the system. One or more vents of a concealed dynamic ventilation system can comprise any of the open/close mechanisms described herein in conjunction with any of the air directing mechanisms described above.

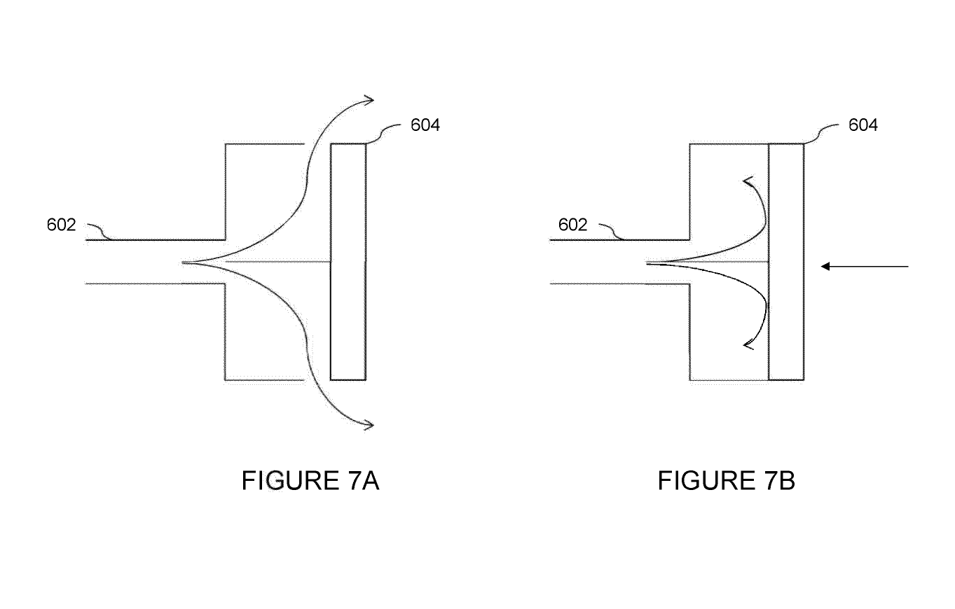

FIGS. 7A-7B show an example of an embodiment of an open/close mechanism of a concealed dynamic ventilation system. In the embodiment depicted in FIG. 7A, one or more vents of a concealed dynamic ventilation system, defined by one or more edges of a trim 604, is in an open state that allows air from an air duct 602 to flow through the one or more vents and into the interior of the vehicle cabin. This or any other open configuration can be selected either automatically or manually when the HVAC system is turned on.

FIG. 7B shows an example of one embodiment of a concealed dynamic ventilation system vent that is in a closed position. In the depicted embodiment, the one or more trims 604 is pushed in towards the rest of the interior surface of the cabin, thereby closing off any opening of the vent. This configuration can partially and/or substantially seal any opening of a vent of a concealed dynamic ventilation system, potentially creating a plenum chamber behind the trim. Accordingly, this configuration can prevent any air flowing from an air duct 602 to reach beyond a surface of the trim 604 into the interior of the cabin. Also, this configuration can substantially prevent any dust and/or other unwanted particles from entering the air duct from the interior of the cabin. This configuration can be automatically and/or manually selected when the HVAC system is turned off and/or when a user wishes to close off a particular concealed dynamic ventilation system opening and/or vent.

In some embodiments, the open/close mechanism shown in FIGS. 7A-7B comprises a spring-loaded mechanism. For example, a rod connected to the interior surface of a trim 604 can comprise a spring mechanism. In some embodiments, when the trim 604 is open, a passenger can simply push the trim 604 inwards to close the vent which can compress the spring. When the trim 604 is closed, a passenger can similarly push the trim 604 inwards which can release the spring and move the trim 604 towards the cabin, thereby opening the vent.

In certain embodiments, the open/close mechanism shown in FIGS. 7A-7B is coupled with an electromechanical system. The electromechanical system can comprise a user interface and a control module. For example, a passenger can input a command via the user interface to open and/or close a particular vent of a concealed dynamic ventilation system. The user interface can be configured to transmit the received command to a control module which can open and/or close that particular vent. Such user interface may be on the trim or panel itself, on a centrally accessible control panel, and/or at any other location. For example, in some embodiments, the user interface can be integrated into one or more mobile devices and/or computing devices of a user.

In some embodiments, a vent of a concealed dynamic ventilation system is configured to open and/or close a particular amount as selected by a passenger. For example, a passenger can choose to open a particular vent by about 0.1 inches, 0.5 inches, and/or 1 inch. By controlling the amount of a particular vent to be open, a passenger can effectively choose the amount of air to be released from a particular vent. In certain embodiments, a passenger can choose to open a particular vent of a concealed dynamic ventilation system by about 0.1 inches, about 0.2 inches, about 0.3 inches, about 0.4 inches, about 0.5 inches, about 0.6 inches, about 0.7 inches, about 0.8 inches, about 0.9 inches, about 1.0 inch, about 1.2 inches, about 1.4 inches, about 1.6 inches, about 1.8 inches, about 2.0 inches, about 2.2 inches, about 2.4 inches, about 2.6 inches, about 2.8 inches, about 3.0 inches, and/or within any range defined by any of the values listed above. Any of the systems described above can be configured to open a particular vent by a width selected by a passenger.

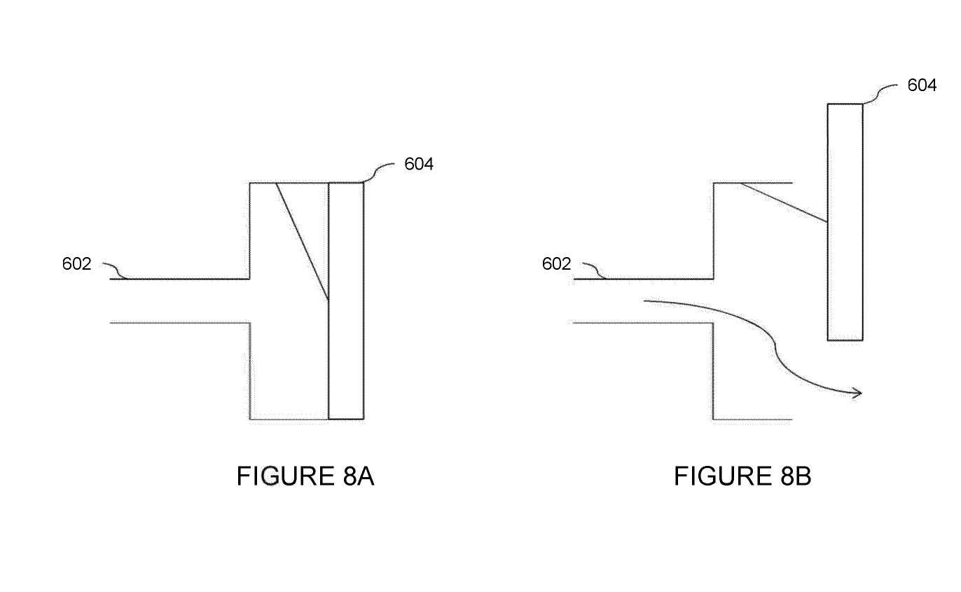

FIGS. 8A-8B show another embodiment of an open/close mechanism of a vent of a concealed dynamic ventilation system. In the embodiment depicted in FIG. 8A, a concealed dynamic ventilation system vent can be closed off by the trims 604 in a similar manner as described above in relation to FIG. 7B. However, when the vent is open to allow air to be directed from an air duct 602 into the interior cabin, the trim 604 is not moved in a purely horizontal direction, as in the embodiment depicted in FIG. 7A. Rather, in the embodiment shown in FIG. 8B, the trim 604 is moved outward away from the air duct 602 and also in an upward and/or downward direction, thereby creating a larger opening below and/or above the trim 604 than in the embodiment shown in FIG. 7A. In other embodiments, a trim 604 can move outwards away from an air duct 602 and also in an upward and/or downward direction to create a substantially larger opening above the trim 604.

In some embodiments, a trim 604 is configured to move outward and upward to create an opening underneath the trim, but not past the top edge of the duct. In certain embodiments, a trim 604 is configured to also move outward and downward to create an opening above the trim, but not past the bottom edge of the duct. In other embodiments, a trim 604 is configured to only move outward and upward such that the opening and/or vent falls out of the line of sight of a passenger in a normal seating position for aesthetic purposes.

In some embodiments, a passenger can grab a trim 604, for example the top and/or bottom edges thereof, to move the trim 604 in one or more manners described above. In certain embodiments, a trim 604 comprises a tactile surface that can allow a passenger to contact the surface of a trim 604 and move the trim 604 in one or more manners described above.

In certain embodiments, the open/close mechanism described in conjunction with FIGS. 8A-8B is configured to be controlled by an electromechanical system. The electromechanical system can comprise a user interface and a control module. A passenger can input a command via the user interface to open and/or close a particular vent a particular amount. The user interface can transmit the received command to a control module which can be configured to mechanically open and/or close a particular vent by a particular amount as selected by the passenger.

The open/close mechanism depicted in FIGS. 8A-8B can provide for stronger air flow, as compared to the open/close mechanism shown in FIGS. 7A-7B, due to the larger opening created by the mechanism. In certain embodiments, a single vent of a concealed dynamic ventilation system can comprise both mechanisms, as shown in FIGS. 7A-7B and FIGS. 8A-8B. This can allow for a user to choose between weaker and stronger air flows.

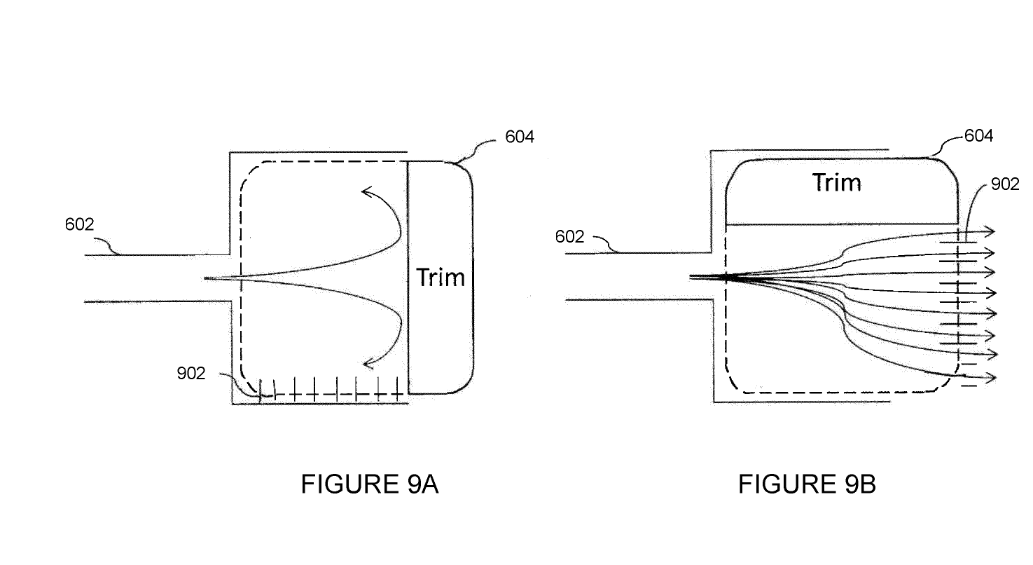

FIGS. 9A-9B depict another example of one embodiment of an open/close mechanism of a concealed dynamic ventilation system. In the depicted embodiment, a trim or “flippers” 604 can be configured to rotate inwards towards the air duct 602 rather than moving out and away from the air duct 602 as in the embodiments shown in FIGS. 7A-8B. FIG. 9A shows an example of one embodiment of a closed vent of a concealed dynamic ventilation system. As illustrated, the trim 604 is substantially blocking the air passageway from the air duct 602. Accordingly, air can be prevented from escaping into the interior of the cabin from the air duct 602. Rather, any air flow coming from the air duct 602 is blocked by the trim 604 and remains inside the air duct. However, in other embodiments, the trim 604 does not substantially block the air passageway from the air duct 602.

When the HVAC system is turned on or when a user turns on this particular opening for air ventilation, the trim or “flipper” 604 can be rotated, as depicted in FIG. 9B. The trim can be substantially square, substantially square with rounded edges, circular, and/or any other shape. The trim 604 can be rotated inward, as shown in FIG. 9B, to create an opening through which air can travel from the air duct 602 into the interior of a cabin. The trim 604 can be configured to be rotated inwards at about 5°, about 10°, about 15°, about 20°, about 25°, about 30°, about 35°, about 40°, about 45°, about 50°, about 55°, about 60°, about 65°, about 70°, about 75°, about 80°, about 85°, or about 90°.

In certain embodiments, a trim 604 can be configured to rotate inwards in a downward direction. In some embodiments, a trim 604 can be configured to rotate inwards in an upward direction. In other embodiments, a trim 604 can be configured to rotate inwards in both an upward and downward direction.

In certain embodiments, one or more side surfaces of a rotating trim or “flipper” 604 can comprise one or more louvers 902. The one or more louvers 902 can be configured to direct the air flow in any direction as selected by the user.

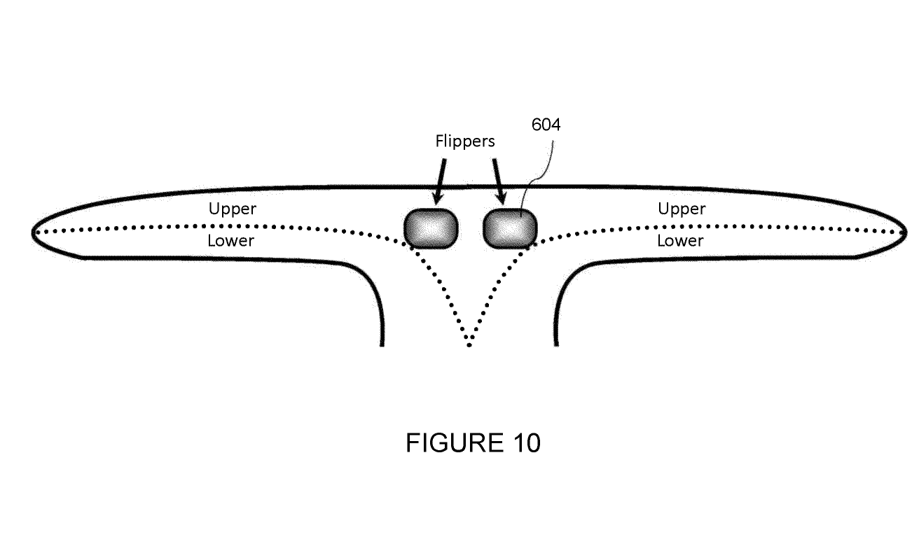

FIG. 10 shows an example of one embodiment of one or more trims 604 with an open/close mechanism (or “flippers”) that are located on a dashboard and/or door panel. As shown in FIG. 10, in some embodiments, one or more vents in a concealed dynamic ventilation system that are configured to open/close can be located on a dashboard and/or door panel. These vents located on a dashboard and/or door panel can comprise one or more open/close mechanisms described herein to allow/prevent air flow into the cabin. Further, in certain embodiments, these vents can be configured to direct air in one or more selected directions according to one or more mechanisms described herein.

Directing Air Within a Duct of a Concealed Dynamic Ventilation System

In order to control the direction of air flow blowing out of a vent, it can be advantageous to be able to control the air flow direction initially within the duct. By controlling the direction of air flow within the duct, the direction of air flow through a vent can be more closely controlled. Accordingly, in some embodiments, a duct of a concealed dynamic ventilation system comprises one or more flaps 1102, 1104 to control the direction of air flow within the duct.

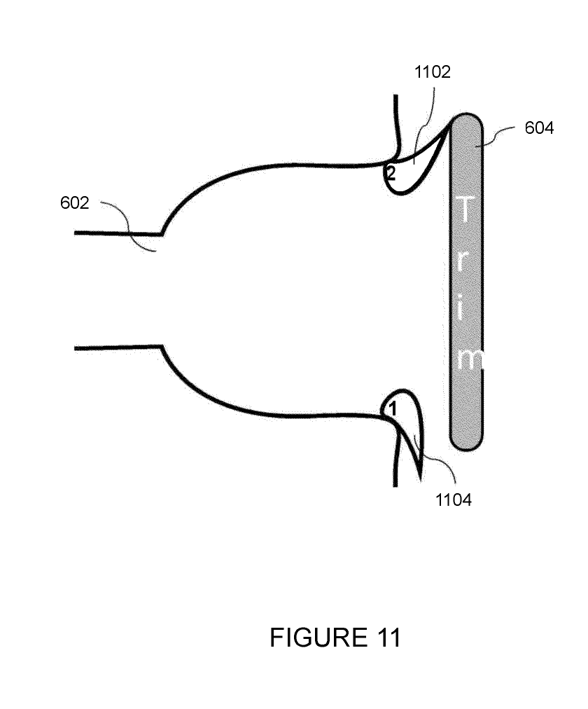

FIG. 11 shows an example of one embodiment of flaps configured to direct air flow out of a duct through a vent of a concealed dynamic ventilation system. In some embodiments, a duct of a concealed dynamic ventilation system comprises one or more flaps 1102, 1104 located near one or more vent openings. These flaps 1102, 1004 can be configured to open and/or close to a certain degree in order to allow and/or block air flow through a vent opening. For example, if a passenger wishes air to blow out through only a top opening of a trim 604, then a flap 1102 associated with the top opening can be configured to substantially open the top opening while a flipper 1104 associated with a bottom opening can be configured to substantially close the bottom opening. In certain embodiments, one or flaps can be configured to allow only a particular percentage of air flow out of a particular opening.

Further, in some embodiments, one or more flaps 1102, 1104 can be configured to accelerate and/or smooth airflow from an air duct 602 through one or more vents. For example, the shape of one or more flaps can comprise a particular curvature to reduce friction of the air flow through the vent in a similar manner as a wing of an airplane. By reducing the friction of air flow via one or more curved flaps, air can more efficiently flow through a vent, thereby decreasing energy consumption and the level of noise.

In some embodiments, the one or more flaps 1102, 1104 can be configured to be controlled electromechanically. An electromechanical system can comprise a user interface and a control module. A passenger can input a command to direct air through a particular vent in a particular direction, for example top, down, left, and/or right. The user interface can transmit the received command to a control module which can be configured to mechanically control one or more flaps 1102, 1104 to block and/or open certain openings to achieve the selected air flow.

In certain embodiments, a passenger can select via the user interface to allow a particular amount of air flow out of a particular opening of a vent. For example, a passenger can select a particular vent to allow roughly 25% of air flow out of a top opening, 25% of air flow out of a bottom opening, 25% of air flow out of a left opening, and 25% of air flow out of a right opening. If a vent only has top and bottom openings or left and right openings or one opening, the user interface can display only the adjustments allowable to a passenger. In some embodiments, a passenger can select a particular opening (left, right, top, and/or bottom) of a particular vent (defined by a particular trim) to allow about 10%, about 20%, about 30%, about 40%, about 50%, about 60%, about 70%, about 80%, about 90%, about 100% of air flow.

Dynamic Thickness of Air Duct

Generally, openings and/or vents located further away from an air source and/or a central fan have weaker air flow, due to the further distance of air travel and/or heightened resistance that hinders air flow. This can result in uneven distribution of air within a cabin. Accordingly, it can be desirable to allow air to more easily reach the vents that are further away, in order to accommodate the otherwise uneven distribution of air. As such, in some embodiments, air ducts of a concealed dynamic ventilation system comprise different thicknesses, depending on the position of the vent that it is configured to deliver air flow to.

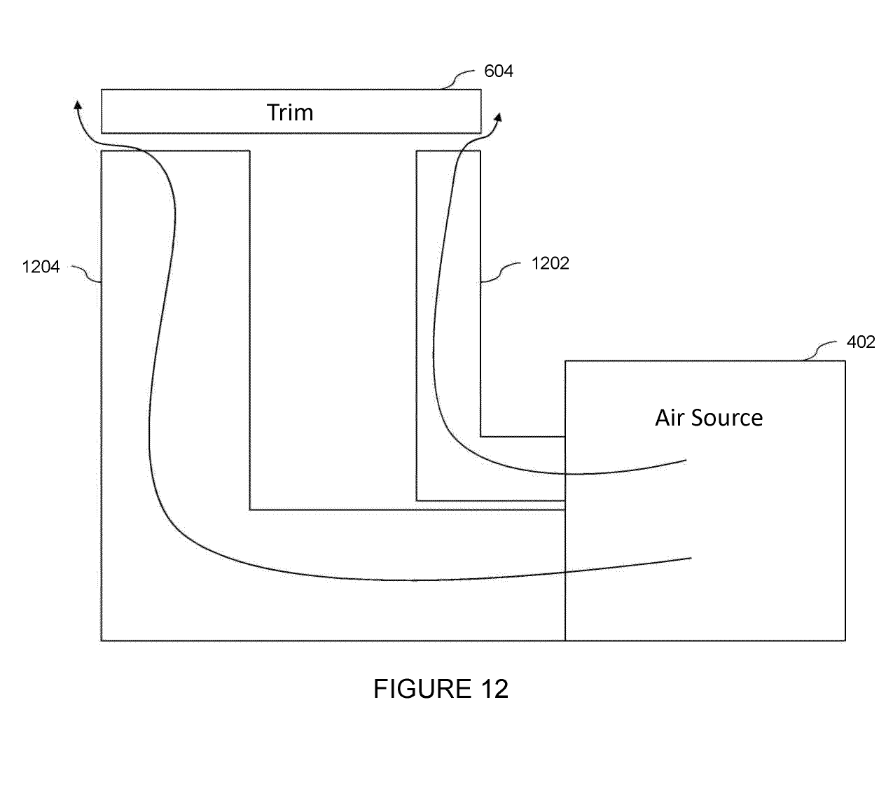

FIG. 12 shows an example of one embodiment of a concealed dynamic ventilation system with air ducts of different thicknesses or diameters, depending on the location of the vent. In the depicted embodiment, air is pumped from an air source and/or fan 402 or other air transfer device through one or more air ducts 1202, 1204. In any HVAC system with multiple vents, certain air ducts are configured to deliver air to vents that are closer to the air source than others. For example, in the depicted embodiment, a first air duct 1202 is designed to deliver air to a first vent that is closer to the air source than compared to a second vent that a second air duct 1204 is configured to deliver air to. Due to the difference in distance of air travel and resistance, it is generally easier to deliver more air to the first vent compared to the second vent, which can lead to uneven distribution of air. Accordingly, in the depicted embodiment, the first air duct 1202 has a smaller diameter compared to the second air duct 1204. The larger diameter of the second air duct 1204 decreases the amount of resistance for air to travel through the second air duct 1204. Because of the lower resistance, air can more easily travel through the second air duct 1204 compared to the first air duct 1202 with a same amount of force exerted by a fan. Accordingly, although generally less air will travel to a vent that is located far away from the air source, a substantially equal and/or comparable amount of air can travel through the second air duct 1204 as through the first duct 1202 despite at a slower velocity per cross sectional area in some embodiments. This can provide a more even air flow throughout all vents of a vehicle.

Laminar Flow

In vehicles with traditional HVAC systems, in order to achieve fast cooling and/or heating, one must increase the air flow rates to a substantial level, which often produces a loud undesirable noise within the cabin. This noise is mainly due to the fact that the air flow in these traditional HVAC systems is substantially turbulent. Accordingly, in order to decrease the unwanted noise levels while allowing for faster cooling and/or heating, laminar air flow is provided in some embodiments of a concealed dynamic ventilation system.

In certain embodiments, the shape of flaps near one or more vents or where the air exits one or more concealed ducts can help to accelerate and smooth airflow resulting in less cabin turbulence. For example, the shape of one or more flaps can comprise a curvature along direction of air flow to smooth the air flow. This can substantially decrease the degree of turbulence of the air flow in some embodiments.

In certain embodiments, a plurality of thinner straws and/or air pipes can be located inside a larger air duct. As such, air can be forced to travel in a substantially linear direction through each individual thinner air pipe. When air travelling through these individual air pipes reaches a vent or opening into the interior cabin, the air flow can be substantially laminar, thereby substantially decreasing any unwanted noises.

In certain embodiments, the individual thin air pipes within an air duct can be positioned to form a substantially honeycomb-shaped cross-section.

Thermoelectric Device

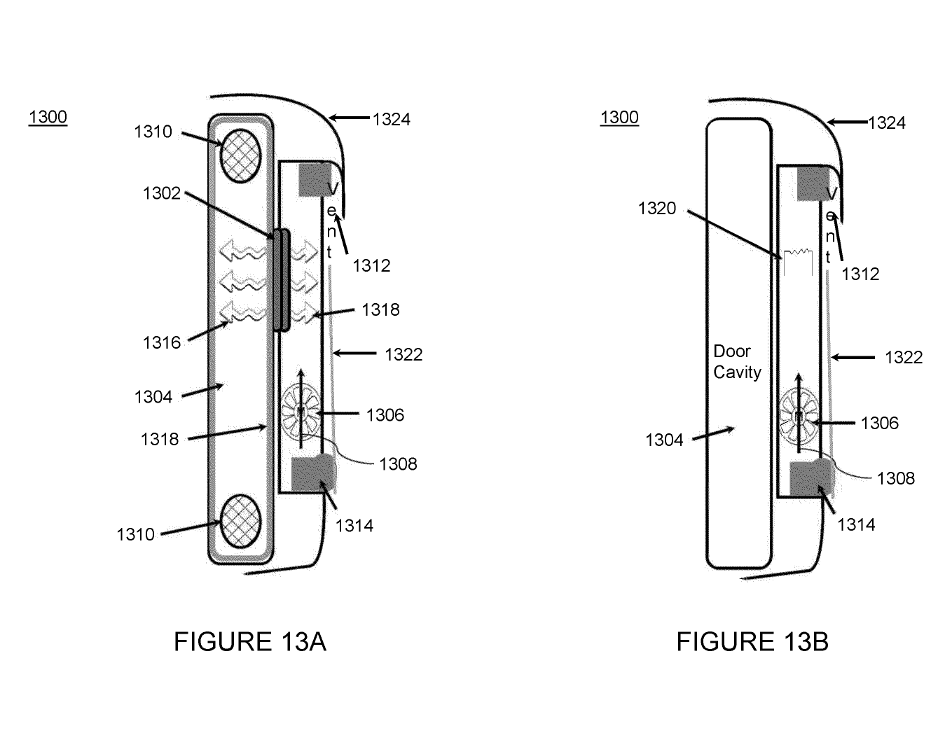

Referring to FIGS. 13A and 13B, cross-section views are shown of a portion of a car door 1300, such as a car side door. The car door 1300 may have a door cavity 1304, an inner door shell 1322, and an upper door shell 1324. In some embodiments, the inner door shell 1322 and the upper door shell 1324 can have a degree of overlap configured to provide a vent 1312 through which air can pass, such that air can be delivered to an interior cabin of the car from a space within the door 1300. For example, the inner door shell 1322 can include a portion of an interior trim and the upper door shell 1324 can include a portion of an interior trim, the vent 1312 being defined at least in part by a space between adjacent surfaces of interior trim portions. The door 1300 may include a door cavity 1304, the door cavity 1304 may or may not include an insulation layer 1318 lining a portion of a door cavity surface. For example, the surface of the door cavity 1304 may be substantially covered by an insulation layer 1318.

As shown in FIG. 13A, a car door portion 1300 can include a thermoelectric device 1302. For example, the thermoelectric device 1302 may be coupled (e.g., mounted) onto a surface within the car door 1300, such as a surface of a wall adjacent to the door cavity 1304 and/or a surface of a wall defining at least a portion of the door cavity 1304 (e.g., a surface of the wall exterior to the door cavity 1304). A thermoelectric device may include a variety of systems suitable for facilitating conversion of electrical energy (e.g., an electrical voltage difference) into thermal energy, for example facilitating a change in a temperature of air adjacent to and/or surrounding the device by releasing and/or absorbing thermal energy. The thermoelectric device can be a peltier type device. In some embodiments, a peltier type device may facilitate a heat flux through a junction between two different types of materials (e.g., between two different types of semiconductor materials, such as between an n-type semiconductor material and a p-type semiconductor material), transferring heat from a first side of the device to a second side of the device using electrical energy (e.g., a current flow). For example, as a current is supplied to a peltier type device, a first side of the device may be heated while a second side of the device may be cooled, the heated side thermally coupled to a heat sink and the cooled side may be used to cool air within a desired space. The thermoelectric device can include other suitable devices, including suitable thermal exchange devices.

With cars going electric and with excess electricity produced at speeds which cannot be used to charge a full battery, electric heating and/or cooling via a peltier type and/or any other suitable thermal exchange device can make use of any excess electricity generated by the car for efficient cooling and/or heating of an interior cabin space of a car. Such a device may provide a compact heating and/or cooling apparatus suitable for placing within various spaces in a car body, including a space within the door 1300. For example, on extremely cold or hot days, such a device can create heating or cooling in a more timely fashion than waiting for the engine to heat up or the AC compressor to deliver chilled refrigerant. Other heating and/or cooling devices may be included in a car door 1300 for providing heated and/or cooled air. In some embodiments, for heating, a more conventional resistive type heating element 1320 may be used. In some embodiments, for cooling, coils containing chilled liquid and/or refrigerant may be used (also represented by 1320).

Undesired heated or cooled air 1316 can be discharged into the door cavity 1304 and/or any other cavity within the car body tolerant of such temperatures and able to contain such heat or cold without discharging the unwanted air 1316 back into the cabin of the vehicle. As described herein, such a cavity could be insulated, such as by an insulating layer 1318. In some embodiments, a door cavity 1304 of the door 1300 can have one or more exhaust vents 1310. The exhaust vent 1310 may be configured to facilitate intake of air from and/or dissipation of air to a space exterior to the door 1300. Radiation of the heat or cold intended for the passenger may be facilitated by an air propulsion device 1306, including a fan, charged ionic plates, any other suitable air propulsion device, and/or combinations thereof. In some embodiments, a door 1300 can include a return air register 1314 located proximate to the air propulsion device 1306 (e.g., as shown in FIGS. 13A and 13B), such that air may be supplied to the air propulsion device 1306. The return air register 1314 may be hidden by an inner door shell portion 1322.

In some embodiments, air 1308 to be cooled and/or heated by a cooling or heating element may be directed over a thermoelectric device 1302 (e.g., a Peltier type heating and/or cooling plate), a resistive heating element 1320, and/or coils having a coolant 1320, placed within a space within the car door 1300. As described herein, the cooling and/or heating apparatus can be quite compact, and consequently can be placed inside a space of a door (e.g., door 1300) and/or any other space within a body panel of the car. Air may flow via convection and/or an air propulsion device (e.g., a propulsion device 1306), facilitating air flow through the air vent 1312 and into the cabin to cosset the passenger. In some embodiments, air vent 1312 may be concealed by an upper door shell 1324 overlapping an inner door shell 1322.

The thermoelectric device 1302, the resistive heating element 1320, and/or the coils having a coolant 1320, may be contained in other suitable spaces within any other car body portion, aside from a car door 1300. For example, thermoelectric device 1302, the resistive heating element 1320, and/or the coils having a coolant 1320 may be placed (e.g., mounted onto a surface) within a space within a car dashboard, a car roof portion, and/or a car seat.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment. The headings used herein are for the convenience of the reader only and are not meant to limit the scope of the inventions or claims.

Although the embodiments of the inventions have been disclosed in the context of a certain preferred embodiments and examples, it will be understood by those skilled in the art that the present inventions extend beyond the specifically disclosed embodiments to other alternative embodiments and/or uses of the inventions and obvious modifications and equivalents thereof. In addition, while a number of variations of the inventions have been shown and described in detail, other modifications, which are within the scope of the inventions, will be readily apparent to those of skill in the art based upon this disclosure. It is also contemplated that various combinations or subcombinations of the specific features and aspects of the embodiments may be made and still fall within one or more of the inventions. Accordingly, it should be understood that various features and aspects of the disclosed embodiments can be combine with or substituted for one another in order to form varying modes of the disclosed inventions. Thus, it is intended that the scope of the present inventions herein disclosed should not be limited by the particular disclosed embodiments described above.

What is claimed is:

1. An apparatus for ventilating an interior of a vehicle, the apparatus comprising:
an air source;
an air duct coupled to the air source; and
a plurality of air vents each having an opening coupled to the air duct configured to deliver air to the interior of the vehicle, and an air vent opening cover over at least a portion of at least one of the plurality of air vent openings, the air vent opening cover comprising a portion of a vehicle interior trim.

2. The apparatus of claim 1, wherein at least one of the plurality of air vent openings has an elongate shape and extends along a length of at least one of a vehicle A pillar and a vehicle B pillar.

3. The apparatus of claim 1, wherein the at least one of the plurality of air vent openings extends along a length of least one of a vehicle dashboard, a vehicle seat, a vehicle door, and a vehicle roof panel.

4. The apparatus of claim 1, wherein the at least one of the plurality of air vent openings is defined at least in part by two adjacent surfaces of a vehicle dashboard trim or an interior vehicle door trim.

5. The apparatus of claim 4, further comprising an air-directing component within the at least one of the plurality of air vent openings, the air-directing component coupled to one of the two adjacent surfaces and configured to rotate around a pivot point or move along an axis to guide air flow through the at least one of the plurality of air vent openings.

6. The apparatus of claim 1, wherein the portion of the vehicle interior trim moves in at least one of a horizontal direction toward the interior of the vehicle, an upward direction and a downward direction.

7. The apparatus of claim 1, wherein the portion of the vehicle interior trim rotates around an axis to vary an amount of air flow through the at least one of the plurality of air vent openings.

8. The apparatus of claim 1, further comprising:
a temperature sensor configured to detect a temperature of the interior of the vehicle; and
a control module configured to receive a signal from the temperature sensor indicative of the temperature in the interior of the vehicle, and to control a movement of the air vent opening cover to direct an air flow through the at least one of the plurality of air vent openings in response to a signal indicating the temperature in the interior of the vehicle is greater than or lower than a threshold temperature value.

9. The apparatus of claim 8, wherein the air vent opening cover rotates around an axis in response to a control signal from the control module.

10. The apparatus of claim 1, wherein a cross-section dimension of the air duct increases as a distance from the air source increases.

11. The apparatus of claim 1, further comprising a thermoelectric device within a space of a vehicle door, the space being coupled to the at least one of the plurality of air vent openings, wherein air heated or cooled by the thermoelectric device is delivered to the interior of the vehicle through the at least one of the plurality of air vent openings.

12. An apparatus for ventilating an interior of a vehicle, the apparatus comprising:
an air source;
an air duct coupled to the air source; and
an air vent having an opening coupled to the air duct for delivering air to the interior of the vehicle, the air vent opening being substantially concealed by a portion of a vehicle interior trim at least when the air vent is in a closed position.

13. The apparatus of claim 12, wherein the air vent opening has an elongate shape and extends along a length of at least one of a vehicle A pillar and a vehicle B pillar.

14. The apparatus of claim 12, wherein the air vent is in a vehicle dashboard, a vehicle seat, a vehicle door, or a vehicle roof.

15. The apparatus of claim 12, wherein the air vent opening is defined at least in part by two adjacent surfaces of a portion of a vehicle dashboard trim or a portion of a vehicle interior door trim.

16. The apparatus of claim 12, wherein the portion of the vehicle interior trim moves in at least one of a horizontal direction toward the interior of the vehicle, an upward direction and a downward direction.

17. The apparatus of claim 12, wherein the portion of the vehicle interior trim rotates around an axis to vary an amount of air flow through the at least one of the plurality of air vent openings.

18. A system for ventilating an interior of a vehicle, the system comprising:
an air vent opening for delivering air to the interior of the vehicle and a corresponding air vent opening cover over the air vent opening, the corresponding air vent opening cover comprising a portion of a vehicle interior trim and substantially concealing the air vent opening.

19. The system of claim 18, wherein the portion of the vehicle interior trim moves in at least one of a horizontal direction toward the interior of the vehicle, an upward direction and a downward direction.

20. The system of claim 18, wherein the portion of the vehicle interior trim rotates around an axis to vary an amount of air flow through the air vent opening.
